(19) United States
(12) Patent Application Publication
(10) Pub. No.: US 2014/0222524 A1
(43) Pub. Date: Aug. 7, 2014

(54) Challenge Ranking Based on User Reputation in Social Network and ECommerce Ratings

(71) Applicant: Mindjet LLC, San Francisco, CA (US)

(72) Inventors: Paul Pluschkell, Pleasanton, CA (US); Dustin W. Haisler, Elgin, TX (US); Daniel Charboneau, Independence, MO (US)

(73) Assignee: Mindjet LLC, San Francisco, CA (US)

(21) Appl. No.: 13/959,733

(22) Filed: Aug. 5, 2013

Related U.S. Application Data
(60) Provisional application No. 61/679,747, filed on Aug. 5, 2012.

(51) Int. Cl. G06Q 10/06

(52) U.S. Cl. CPC G06Q 10/0637
USPC 705/7.36

(57) ABSTRACT

A network-based rating system provides a mechanism whereby users can submit and rate challenges in a challenge processing step and submit and rank ideas in an idea processing step that correspond to the challenges in the challenge processing step. The highest rated challenge is determined in the challenge processing step and is then submitted to users in an idea processing step. Alternatively, challenges submitted by users in the challenge processing step are submitted to users for ideas in the idea processing step on an ongoing basis. In these alternative embodiments, the challenge rated in the idea processing step is a challenge other than the highest rated challenge determined in the challenge processing step. In another embodiment, the users rating challenges are the same users rating ideas in the idea processing step and in other embodiments the users are not the same as those rating ideas in the idea processing step.

### CROSS REFERENCE TO RELATED APPLICATION

This application claims the benefit under 35 U.S.C. §119 from provisional U.S. patent application Ser. No. 61/679,747, entitled “Challenge Ranking Based on User Reputation in Social Network and Ecommerce Rating Systems,” filed on Aug. 5, 2012, the subject matter of which is incorporated herein by reference.

### BACKGROUND INFORMATION

Identifying and solving strategic challenges are critical activities that can greatly influence an organization's success. Examples of strategic challenges that many companies experience include what new products or product features are required by the marketplace. Other companies have challenges regarding how to reduce costs or how to raise capital. The ability of organizations to identify these challenges can be determinative of the organization's success. This ability can also be a competitive advantage for the organization if the company is able to identify and solves strategic challenges faster than its competitors. Many companies, however, do not use efficient processes for identifying and solving strategic challenges.

Companies also tend to rely on a few individuals to identify and solve the organization's strategic challenges. Companies may also employ serial approaches to identify these challenges. For example, a corporation may rely on a single executive sponsor to identify and propose a strategic challenge to all other employees of the company. After this first challenge has been solved, the sponsor may then identify and propose subsequent challenges. Because this process is inefficient and does not utilize more employees in the challenge identification process, a better methodology is desired.

### SUMMARY

A network-based rating system provides a mechanism whereby users can submit and rate challenges in a challenge processing step and submit and rank ideas in an idea processing step that correspond to the challenges submitted in the challenge processing step. In one embodiment the highest rated challenge is determined in the challenge processing step and then that challenge is submitted to users in an idea processing step. In other embodiments, challenges submitted by users in the challenge processing step can be submitted to users for ideas in the idea processing step on an ongoing and constant basis. In these alternative embodiments, the challenge rated in the idea processing step is a challenge other than the highest rated challenge determined in the challenge processing step. In yet another embodiment, the users rating challenges in the challenging processing step are the same users rating ideas in the idea processing step. In other embodiments the users rating challenges in the challenging processing step are not the same users rating ideas in the idea processing step.

The manner in which the rating system operates in rating and ranking the challenges is similar to the operation of the system when rating and ranking ideas. In one novel aspect, a user provides an actual rating (AR) of a second challenge submitted by another user in response to a first challenge. The AR is multiplied by a weighting factor to determine a corresponding effective rating (ER) for second challenge. Rather than the ARs of challenges being averaged to determine a ranking of the challenges, the ERs of challenges are averaged to determine a ranking of challenges. The ERs regarding the challenges submitted by a particular user are used to determine a quantity called the “reputation” RP of the user. The reputation of a user is therefore dependent upon what other users thought about challenges submitted by the user. Such a reputation RP is maintained for each user of the system. The weighting factor that is used to determine an ER from an AR is a function of the reputation RP of the user who submitted the AR. If the user who submitted the AR had a higher reputation (RP is larger) then the AR of the user is weighted more heavily, whereas if the user who submitted the AR had a lower reputation (RPT is smaller) then the AR of the user is weighted less heavily.

In a second novel aspect, the weighting factor used to determine an ER from an AR is also a function of a crowd voting probability value PT. The crowd voting probability value PT is a value that indicates the probability that the user who submitted the AR acts with the crowd in generating ARs. The crowd is the majority of a population that behaves in a similar fashion. The probability value PT is determined by applying the Bayes theorem rule and taking into account the number of positive and negative votes. If the user who generated the AR is determined to have a higher probability of voting with the crowd (PT is closer to 1) then the AR is weighted more heavily, whereas if the user who generated the AR is determined to have a lower probability of voting with the crowd (PT is closer to 0) then the AR is weighted less heavily.

In a third novel aspect, the weighting factor used to determine an ER from an AR is a function of the freshness RF of the AR. If the AR is relatively old (RF is a large value) then the AR is weighed less heavily, whereas if the AR is relatively fresh (RF is a small value) then the AR is weighed more heavily.

In a fourth novel aspect, a decay value D is employed in determining a user's reputation. One component of the user's reputation is an average of ERs submitted in the current computing cycle. A second component of the user's reputation is a function of a previously determined reputation RPT−1 for the user from the previous computing cycle. The component of the user's reputation due to the prior reputation RPT−1 is discounted by the decay value D. If the user was relatively inactive and disengaged from the system then the decay value D is smaller (not equal to 1 but a little less, for example, D=0.998) and the impact of the user's earlier reputation RPT−1 is discounted more, whereas if the user is relatively active and engaged with the system then the decay value D is larger (for example, D=1) and the impact of the user's earlier reputation RP−1 is discounted less. As users submit ARs and ROs and use the system, the reputations of the users change. The network-based rating system is usable to solicit and extract challenges from a group of users, and to determine a ranking of the challenges to find the challenge that is likely the best. A ranking of challenges in order of the highest average of ERs for the challenge to the lowest average of ERs for the challenge is maintained and is displayed to users. At the end of a challenge processing period, the highest rated challenge is determined and that challenge is submitted to users in the idea processing step.

Further details and embodiments and techniques are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a drawing of a network-based rating system.

FIG. 2 is a flowchart of an innovation process in accordance with one novel aspect.

FIG. 3 is a flowchart of a method of operation of the network based rating system 1 in accordance with one novel aspect.

FIG. 4 is a flowchart of a method of operation of the network based rating system 1 for receiving, rating, and selecting challenges.

FIG. 5 is a flowchart of a method of operation of the network based rating system 1 for receiving, rating, and selecting ideas.

FIG. 6 is an illustration of a screen shot of what is displayed on the screen of a network appliance when a system administrator or executive sponsor is posting a first challenge.

FIG. 7 is an illustration of a screen shot of how the first challenge is presented to users of the system.

FIG. 8 is an illustration of a page displayed on the screen of a user's network appliance after the user has entered a second challenge into the page but before the user has selected the “SUBMIT” button.

FIG. 9 is an illustration of a page that displays challenges to the users of the system and solicits the users to submit actual ratings (ARs).

FIG. 10 is an illustration of a page that displays a ranking of second challenges that have been submitted by users in response to a first challenge.

FIG. 11 is an illustration of a screen shot of what is displayed on the screen of the network appliance of the administrator ADMIN when the ADMIN is posting a challenge soliciting ideas to solve the highest ranked challenge from FIG. 10.

FIG. 12 is an illustration of a screen shot of how the highest ranked challenge is presented to users of the system before the user submits the user's idea for solving the challenge.

### DETAILED DESCRIPTION

Reference will now be made in detail to some embodiments of the invention, examples of which are illustrated in the accompanying drawings.

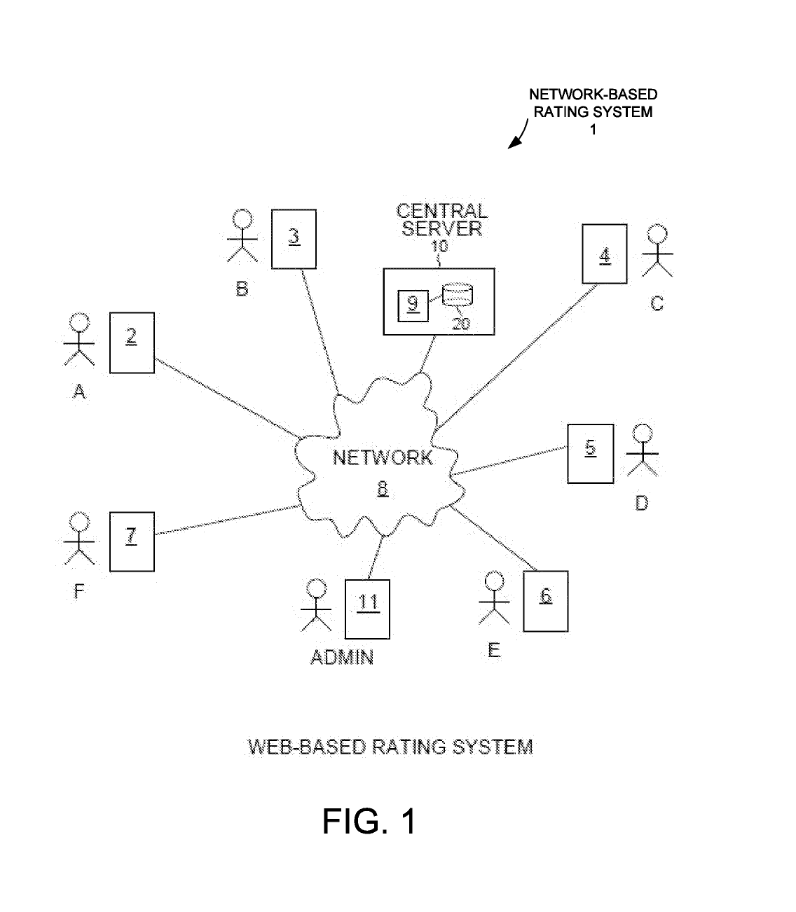

FIG. 1 is a diagram of a network-based rating system 1 in accordance with one novel aspect. Each of the users A-F uses an application (for example, a browser) executing on a networked appliance to communicate via network 8 with a rating system program 9 executing on a central server 10. Rating system program 9 accesses and maintains a database 20 of stored rating information. Blocks 2-7 represent networked appliances. The networked appliance of a user is typically a personal computer or cellular telephone or another suitable input/output device that is coupled to communicate with network 8. Each network appliance has a display that the user of the network appliance can use to view rating information. The network appliance also provides the user a mechanism such as a keyboard or touchpad or mouse for entering information into the rating system.

Network 8 is typically a plurality of networks and may include a local area network and/or the internet. In the specific example described here, a company is interested in producing environmentally sustainable or ecologically “friendly” products wants to effectively and efficiently identify several strategic challenges associated with producing these ecologically friendly products. The users A-F are employees of the company and may include an executive sponsor. The network 8 is an intra-company private computer network maintained by the company for communication between employees when performing company business. The rating system program 9 is administered by the network administrator ADMIN of the company network 8. The administrator ADMIN interacts with network 8 and central server 9 via network appliance 11.

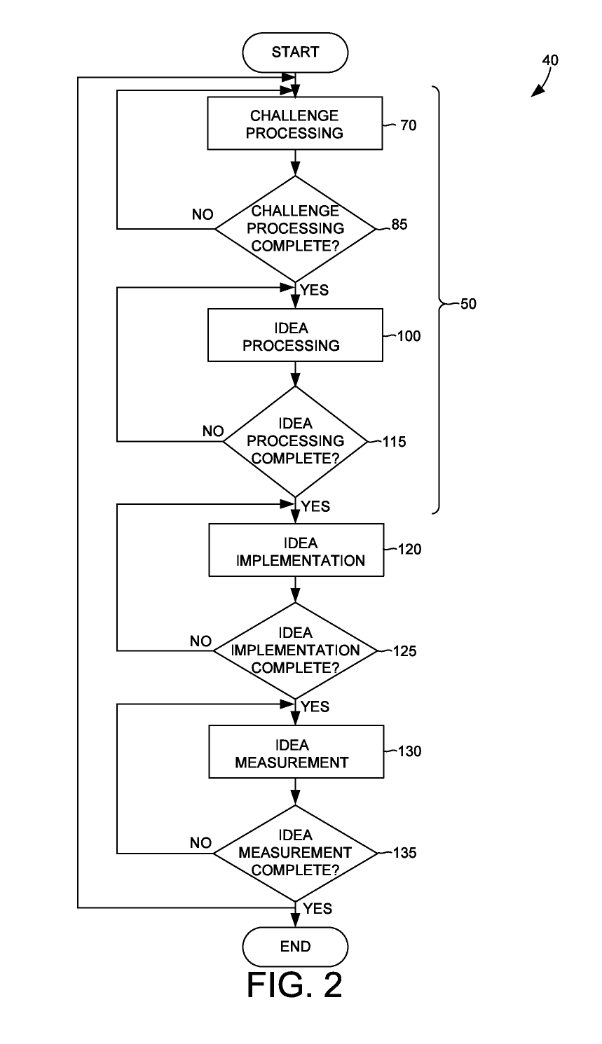

FIG. 2 is a flowchart of an innovation process. In step 70, the challenge processing step, challenges are identified, validated, and selected. In step 70, an executive sponsor or employee of a company may identify a certain challenge such as a recurring point of frustration of one or several of the company's present or future customers. During validation of the challenge, employees of the company may vote, refine, rate and rank the challenges of other employees. After a challenge is selected as a result of the validation step, the challenge is queued for idea submissions. In a step 85, a determination of whether challenge processing is completed is made. If further challenge processing is required, step 70 continues and if not, idea processing begins.

In the idea processing step 100, the challenge selected in the challenge processing step is opened to the employees of the company for idea submissions. Any ideas submitted then proceed through validation, evolution, selection, and funding processes within step 100. For example, the employees of the company may submit ideas to solve the challenge selected in step 70. Ideas are reviewed by the employees or “crowd” through voting, rating, ranking, page views, and other mechanisms. The ranked ideas are passed through a process that refines the original concepts for those ideas and then the top ideas are selected and the idea funding process within step 115 occurs. During the idea funding process, employees have an opportunity to select ideas on which to spend pre-budgeted innovation funds. Next a determination is made in step 115 that idea processing is complete. If the selection has not been made then further idea processing can continue. In alternative embodiments, the process can return to the challenge processing stage for further identification, validation, and selection of challenges.

In the idea implementation step, step 120, the funded ideas are implemented. Once the ideas are implemented, then a determination is made whether the ideas implementation step is complete in a step 125. If the idea implantation is complete then an idea measurement step 130 commences. If idea implementation is not complete, the idea implementation phase can continue. In alternative embodiments, the process can return to the idea processing step 100 or the challenge processing step 70 after step 120.

In an idea measurement step 130, the employees review whether the implemented ideas of the previous step, solved the original challenge submitted during the challenge processing step. If a determination is made in a step 135 that idea measurement has completed then step 70, the challenge processing step, can be repeated. If not, further idea measurement may continue. In one novel embodiment, the innovation process of FIG. 2 can begin or continue at any point within the process.

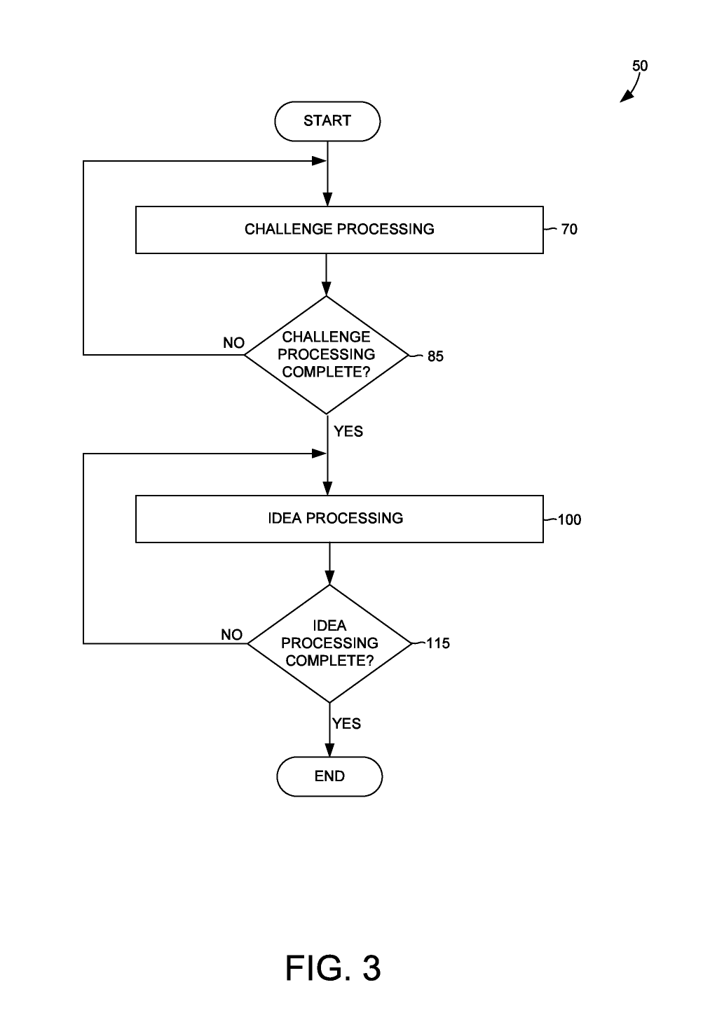

FIG. 3 is a flowchart of a method 50 involving the operation of the network-based rating system of FIG. 1. FIG. 3 includes a portion 50 of the innovation process of FIG. 2. In a challenge processing step (step 70) a network-based rating system is used i) to propose a first challenge to users of the rating system; ii) to rate second challenges received in response to the first challenge; and iii) select a ranked challenge. Once the challenge processing step is complete (step 80), ideas for solving the challenges identified in step 70 are submitted, rated, and selected in an idea processing step (step 100). Once the idea processing step is complete, subsequent steps (not shown) may occur. Process steps that include funding or implementation of the ideas selected in the idea processing step are examples of subsequent processing steps. In an alternative embodiment, the idea and challenge processing steps occur simultaneously. The challenge processing step (step 70) and the idea processing step (step 100) will now be discussed in more detail.

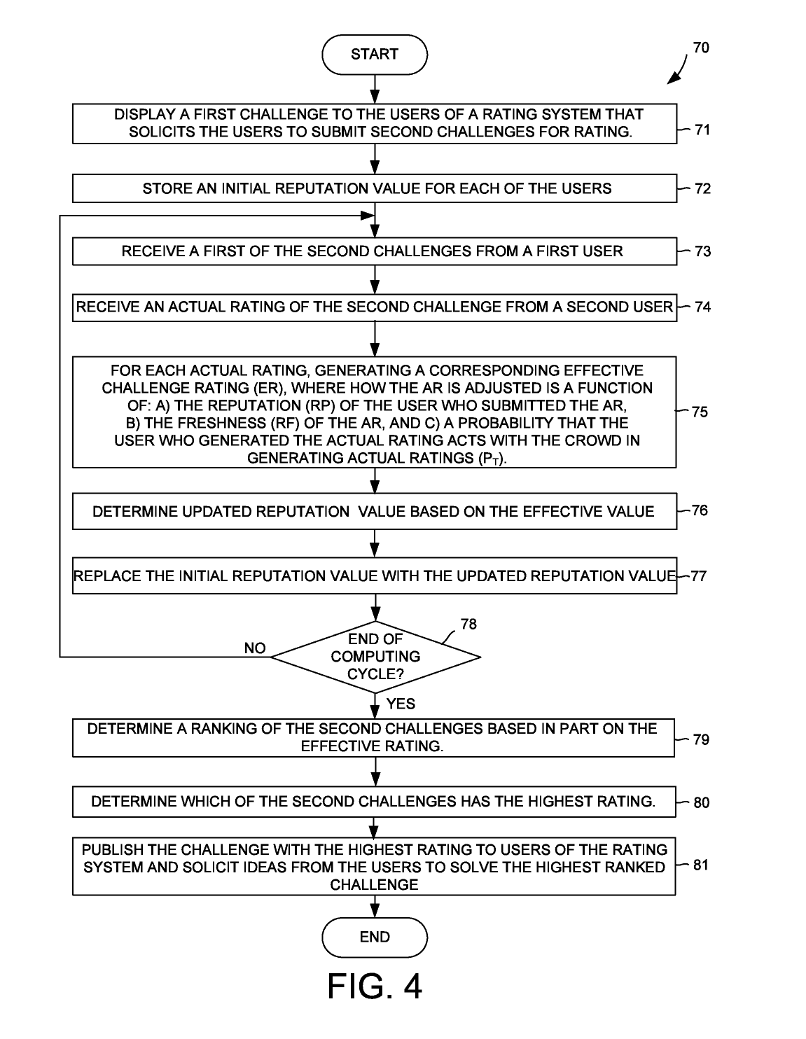

FIG. 4 is a flowchart of a method 70 involving an operation of the network-based rating system 1 of FIG. 1. The administrator ADMIN or an executive sponsor interacts with the rating system program 9, thereby causing a first challenge to be displayed to users A-F of the rating system of FIG. 1. This first challenge solicits the users to submit second challenges that will then be rated by the users A-F. The first challenge may be a solicitation to submit challenges for defining new products or product roadmaps for the company, product features, or any other strategic issue relating to the company or the marketplace in which the company competes with other organizations. Through the system, each user is notified of the initial challenge via the user's networked appliance. In the present example, the initial challenge is titled “HOW CAN WE MAKE OUR PRODUCTS MORE ENVIRONMENTALLY FRIENDLY?” The web page that presents the first challenge to a user also includes a text field. The web page solicits the user to enter into the text field the user's challenge, or a second challenge, in response to the first challenge proposed to the users.

In the method of FIG. 4, a user views the challenge web page and in response types the second challenge into the text box. The user's challenge may be, respective to that specific user, a challenge that they believe is most relevant to meeting the corporate objectives framed by the ADMIN or the executive sponsor in the first challenge. In this example, the first of the second challenges submitted by a user of the rating system is “HOW CAN THE COMPANY REDUCE THE POWER CONSUMPTION OF OUR PRODUCTS.” After typing the first of the second challenges in response to the first challenge, the user selects a “SUBMIT” button on the page, thereby causing the second challenge to be submitted to and received by (step 73) the rating system. Multiple such responsive or second challenges can be submitted by multiple users in this way. An individual user may submit more then one responsive challenge if desired. As these second challenges are submitted and received by the rating system, a list of all the submitted challenges is presented to the users of the system. A user can read the challenges submitted by other users, consider the merits of those second challenges, and then submit ratings corresponding to those challenges. The rating is referred to here as an “actual rating” or an “AR”. In the present example, along with each responsive challenge displayed to the user, is a pair of buttons. The first button is denoted “−1”. The user can select this button to submit a negative rating or a “no” vote for the second challenge. The second button is denoted “+1”. The user can select this button to submit a positive rating or a “yes” vote for the responsive challenge. In the method of FIG. 4, the user selects the desired button, thereby causing the actual rating to be submitted to and received (step 74) by the system. Before the user submits the AR, the user cannot see the number of +1 ARs and the number of −1 ARs that the second challenge has received. This prohibits the user from being influenced by how others have voted on the rated object. The system records the AR in association with the responsive challenge to which the AR pertains. Multiple ARs are collected in this way for every challenge from the various users of the system.

Rather than just using the raw ARs to determine a consensus of what the users think the best challenge is, each AR is multiplied by a rating factor to determine an adjusted rating referred to as an “Effective Rating” or an “ER” (step 75). How the AR is adjusted to determine the associated ER is a function of: A) a previously determined reputation (RP) of the user who submitted the AR, B) the freshness (RF) of the AR, and C) a probability that the user who generated the AR acts with the crowd in generating ARs. The details of how an ER is determined from an AR is described in further detail below.

The Reputation (RP) of a user is used as an indirect measure of how good the challenges submitted the user tend to be. The user's reputation is dependent upon ERs derived from the ARs received from other users regarding the challenges submitted by the user and the rating system sets an initial reputation for each user (step 72). Accordingly, in the example of FIG. 4, after a new actual rating AR is received regarding the second challenge of a user, the reputation of the user is updated (step 76) and replaces that user's initial reputation (step 77). If the current computing cycle has not ended, then processing returns to step 73 and new challenges submitted by users in response to the first challenge may be received into the system. Users may submit actual ratings on various ones of the second challenges. Each time an actual rating is made, the reputation of the user who generated the second challenge is updated.

After the replacing of the initial reputation value with the updated reputation value of step 77 has been performed, then the next computing cycle starts and processing returns to step 73 as indicated in FIG. 4. Operation of the rating system proceeds through steps 73 through 77, from computing cycle to computing cycle, with second challenges being submitted and actual ratings on the second challenges being collected. Each actual rating is converted into an effective rating, and the effective ratings are used to update the reputations of the users as appropriate. After a certain amount of time, the system determines (step 78) that the challenge period is over.

At the end of the computing cycle (step 78), processing proceeds to step 79. For each second challenge, the effective ratings for that second challenge are used to determine a rank (step 79) of the challenge with respect to other challenges. A determination of the highest ranked challenge is also made (step 80). The ranking of all challenges submitted is also displayed to the users A-F. In the illustrated specific embodiment, step 79 occurs near the end of each computing cycle. In other embodiments, the ranking of challenges can be done on an ongoing and constant basis. Computing cycles can be of any desired duration.

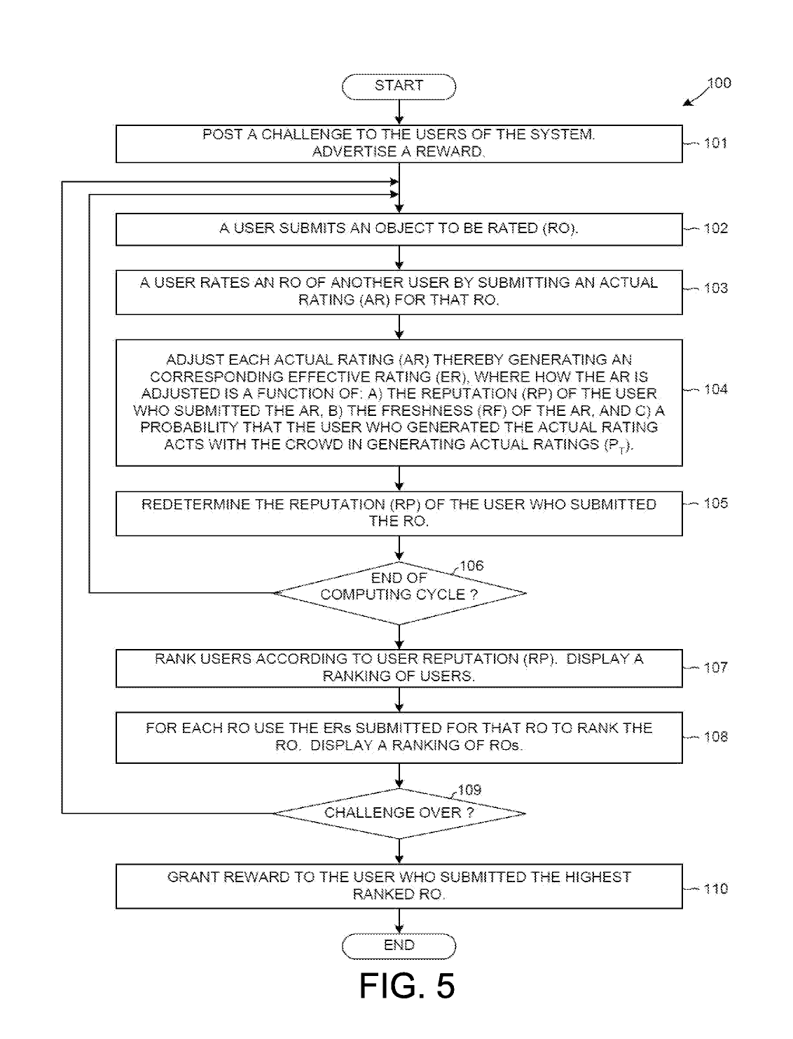

FIG. 5 is a flowchart of the method 100 of FIG. 3 involving an operation of the network-based rating system 1 of FIG. 1. The administrator ADMIN interacts with the rating system program 9, thereby causing the highest ranked challenge to be posted (step 101) to the users A-F of the system. The highest ranked challenged was determined by the challenge processing step (step 80) of FIG. 3. Through the system, each user is notified of the challenge via the user's networked appliance. In the present example, the challenge is titled “HOW CAN THE COMPANY REDUCE THE POWER CONSUMPTION OF OUR PRODUCTS?” The web page that presents this challenge to a user also includes a text field. The web page solicits the user to type the user's idea into the text field.

In the method of FIG. 5, a user views this challenge-advertising web page and in response types the user's idea into the text box. The user's idea is an object to be rated or a “rated object” in this step. After typing the idea for how the company can reduce power consumption in its products into the text box, the user selects a “SUBMIT” button on the page, thereby causing the Rated Object (RO) to be submitted (step 102) to the rating system. Multiple such ROs are submitted by multiple users in this way. An individual user may submit more than one RO if desired. As ROs are submitted, a list of all the submitted ROs is presented to the users of the system. A user can read the rated objects (ROs) submitted by other users, consider the merits of those ROs, and then submit ratings corresponding to those ROs in a manner similar to that in which second challenges are rated in the challenge processing step 70 of FIG. 3. The rating is referred to here as an “actual rating” or an “AR”. In the present example, along with each idea displayed to the user, is a pair of buttons. The first button is denoted “−1”. The user can select this button to submit a negative rating or a “no” vote for the idea. The second button is denoted “+1”. The user can select this button to submit a positive rating or a “yes” vote for the idea. In the method of FIG. 3, the user selects the desired button, thereby causing the Actual Rating AR to be submitted (step 103) to the system. Before the user submits the AR, the user cannot see the number of +1 ARs and the number of −1 ARs the RO has received. This prohibits the user from being influenced by how others have voted on the RO. The system records the AR in association with the RO (the rated object) to which the AR pertains. Multiple ARs are collected in this way for every RO from the various users of the system.

Rather than just using the raw ARs to determine a consensus of what the users think the best submitted idea is, each AR is multiplied by a rating factor to determine (step 104) an adjusted rating referred to as an “Effective Rating” or an “ER”. How the AR is adjusted to determine the associated ER is a function of: A) a previously determined reputation (RP) of the user who submitted the AR, B) the freshness (RF) of the AR, and C) a probability that the user who generated the AR acts with the crowd in generating ARs. The details of how an ER is determined from an AR is described in further detail below.

The reputation (RP) of a user is used as an indirect measure of how good ROs of the user tend to be. The user's reputation is dependent upon ERs derived from the ARs received from other users regarding the ROs submitted by the user. Accordingly, in the example of FIG. 5, after a new actual rating AR is received regarding the rated object (the RO) of a user, the reputation of the user is redetermined (step 105). If the current computing cycle has not ended, then processing returns to step 102. New rated objects may be received into the system. Users may submit ARs on various ones of the ROs displayed to the users. Each time an AR is made, the reputation of the user who generated the RO is updated.

At the end of the computing cycle (step 106), processing proceeds to step 107. The system determines a ranking of the users (step 107) based on the reputations (RP) of the users at that time. The ranking of users is displayed to all the users A-F. In addition, for each RO the ERs for that RO are used to determine a rank (step 108) of the RO with respect to other ROs. The ranking of all ROs submitted is also displayed to the users A-F. In the illustrated specific embodiment, steps 107 and 108 occur at the end of each computing cycle. In other embodiments, the ranking of users and the ranking of ROs can be done on an ongoing constant basis. Computing cycles can be of any desired duration.

After the rankings of steps 107 and 108 have been performed, then the next computing cycle starts and processing returns to step 102 as indicated in FIG. 5. Operation of the rating system proceeds through steps 102 through 109, from computing cycle to computing cycle, with ROs being submitted and ARs on the ROs being collected. Each AR is converted into an ER, and the ERs are used to update the reputations of the users as appropriate. The ranking of users is displayed to all the users of the system in order to provide feedback to the users and to keep the users interested and engaged with the system. The public ranking of users incentivizes the users to keep using the system and provides an element of healthy competition.

After a certain amount of time, the system determines (step 109) that the challenge period is over. In the illustrated example, the highest ranked idea (highest ranked RO) is determined to be the winner of the challenge. The user who submitted that highest ranked RO is alerted by the system that the user has won the reward (step 110) for the best idea. The public nature of the reward and the public ranking of users and the public ranking of ideas is intended to foster excitement and competition and future interest in using the rating system.

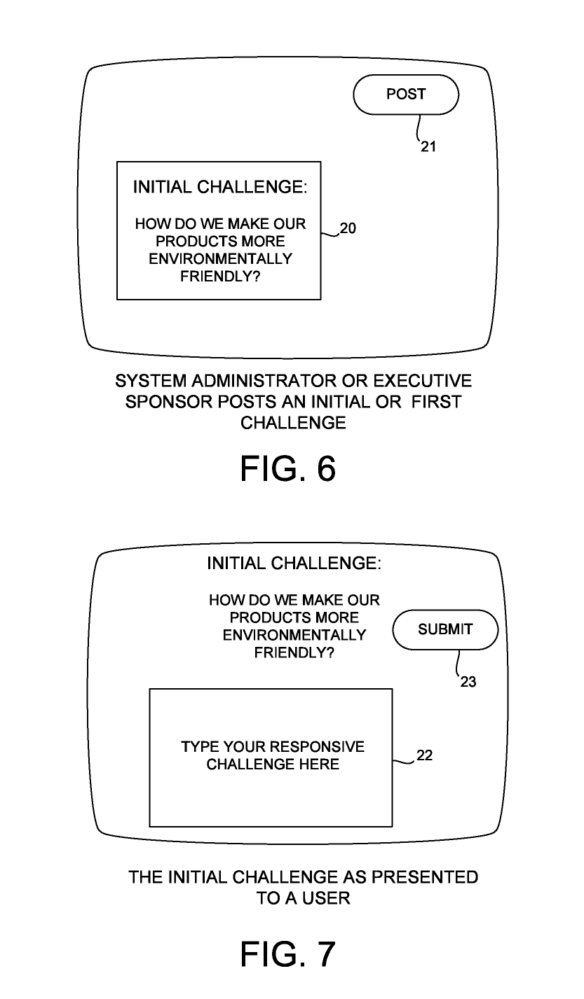

FIG. 6 is an illustration of a screen shot of what is displayed on the screen of the network appliance of the administrator ADMIN of the system. The ADMIN is being prompted to post a first challenge. The ADMIN types a description of the challenge into text box 20 as illustrated, and then selects the “POST” button 21. This causes the first challenge to be submitted to the system. Alternatively, an executive sponsor may also post and submit the first challenge.

FIG. 7 is an illustration of a screen shot of what is then displayed to the users A-F of the system. The initial challenge is advertised to the users. The text box 22 presented prompts the user to type a second challenge in response to the first challenge into the text box 22. After the user has entered the responsive challenge, the user can then select the “SUBMIT” button 23 to submit the second challenge to the system.

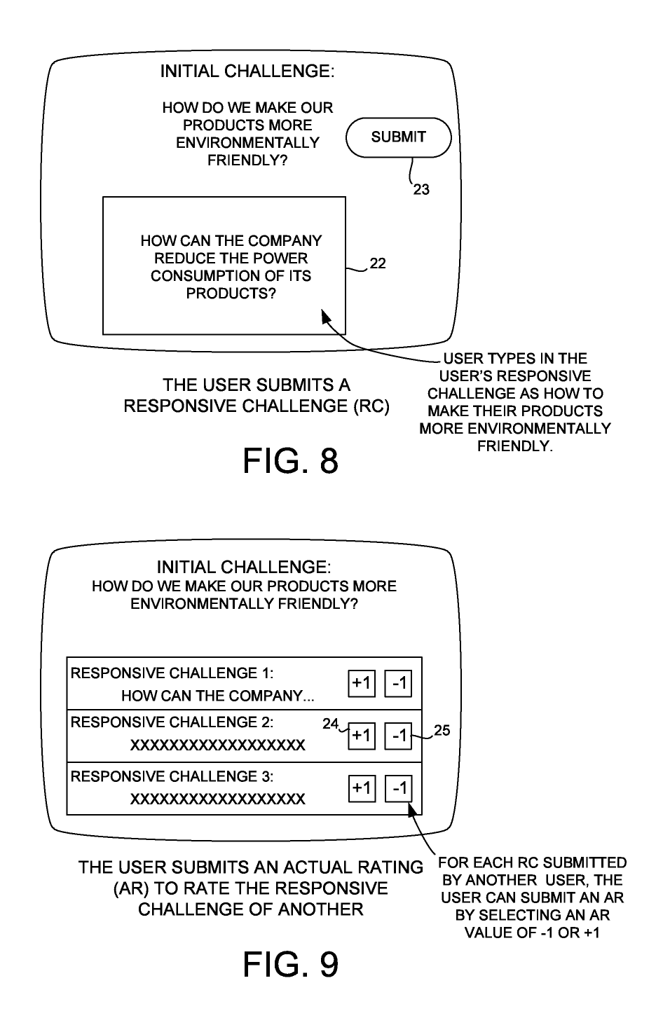

FIG. 8 is an illustration of a page displayed on the screen of a user's network appliance. The user has entered a second challenge (has typed in a challenge that the user feels best addresses the first challenge of how to make the company's products more environmentally friendly) into the text box 22 before selecting the “SUBMIT” button 23. In this example, the user's challenge is “How can the company reduce the power consumption of its products?”

FIG. 9 is an illustration of a page displayed on the screen of the network appliance of each user of the system. The page shows each user submitted second challenge as of the time of viewing. For each second challenge, the user is presented an associated “−1” selectable button and an associated “+1” selectable button. For example, if the user likes the challenge listed as “CHALLENGE 2”, then the user can select the “+1” button 24 to the right of the listed “CHALLENGE 2”, whereas if the user does not like the challenge listed as “CHALLENGE 2” then the user can select the “−” button 25 to the right of the listed “CHALLENGE 2.” Each user is informed of all of the submitted challenges using this page, and the user is prompted to vote (submit an AR) on each challenge using this page.

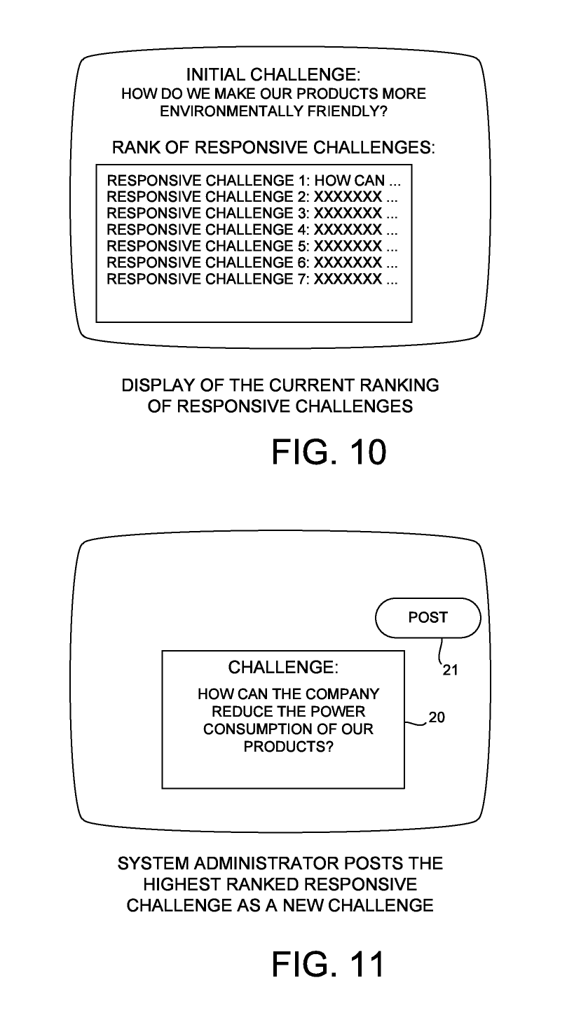

FIG. 10 is an illustration of a page displayed on the screen of the network appliances of each user of the system. The page shows the current ranking of all second challenges received in response to the first challenge.

FIG. 11 is an illustration of a screen shot of what is displayed on the screen of the network appliance of the administrator ADMIN of the system. The ADMIN is being prompted to post a first challenge. The ADMIN types a description of the challenge into text box 26 as illustrated, and then selects the “POST” button 27. This causes the challenge to be submitted to the system. The challenge in this example is the highest rated of the second challenges submitted by users in response to the first challenge when the last challenge ended. The title of this challenge is: “HOW CAN THE COMPANY REDUCE THE POWER CONSUMPTION OF OUR PRODUCTS?”

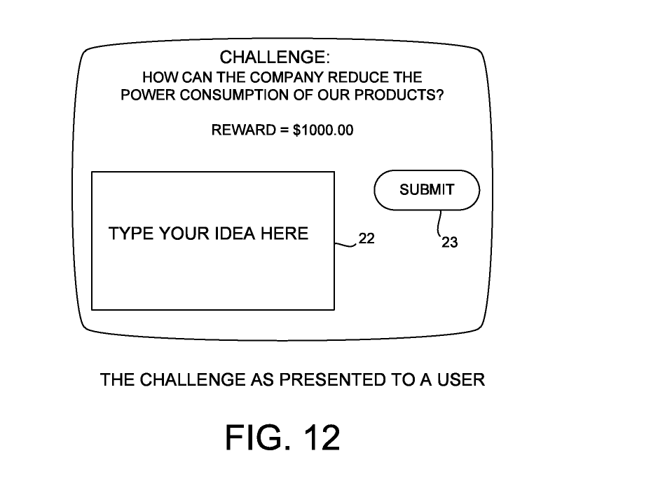

FIG. 12 is an illustration of a screen shot of what is then displayed to the users A-F of the system. The challenge of FIG. 11 is advertised to the users. The text box 28 presented prompts the user to type an idea into the text box 28. The user's idea is a solution to the challenge proposed in FIG. 11. After the user has entered his or her idea (which is the object to be rated or “RO”), the user can then select the “SUBMIT” button 29 to submit the RO to the system. This differs from the initial challenge previously presented to the users in FIG. 7. FIG. 7 prompted the users to enter a second challenge in response to the first challenge.

The manner in which the rating system operates in rating and ranking the second challenges is similar to the operation of the system when rating and ranking ideas. In one novel aspect, each AR is multiplied by a weighting factor to determine a corresponding effective rating (ER) for second challenge. Rather than the ARs of challenges being averaged to determine a ranking of the challenges, the ERs of challenges are averaged to determine a ranking of challenges. The ERs regarding the challenges or ideas submitted by a particular user are used to determine a quantity called the “reputation” RP of the user. The reputation of a user is therefore dependent upon what other users thought about challenges submitted by the user. Such a reputation RP is maintained for each user of the system. The weighting factor that is used to determine an ER from an AR is a function of the reputation RP of the user who submitted the AR. If the user who submitted the AR had a higher reputation (RP is larger) then the AR of the user is weighted more heavily, whereas if the user who submitted the AR had a lower reputation (RPT is smaller) then the AR of the user is weighted less heavily.

In a second novel aspect, the weighting factor used to determine an ER from an AR is also a function of a crowd voting probability value PT. The crowd voting probability value PT is a value that indicates the probability that the user who submitted the AR acts with the crowd in generating ARs. The crowd is the majority of a population that behaves in a similar fashion. The probability value PT is determined by applying the Bayes theorem rule and taking into account the number of positive and negative votes. If the user who generated the AR is determined to have a higher probability of following the other users or voting with the crowd (PT is closer to 1) then the AR is weighted more heavily, whereas if the user who generated the AR is determined to have a lower probability of following other users or voting with the crowd (PT is closer to 0) then the AR is weighted less heavily.

In a third novel aspect, the weighting factor used to determine an ER from an AR is a function of the freshness RF of the AR. If the AR is relatively old (RF is a large value) then the AR is weighed less heavily, whereas if the AR is relatively fresh (RF is a small value) then the AR is weighed more heavily.

In a fourth novel aspect, a decay value D is employed in determining a user's reputation. One component of the user's reputation is an average of ERs submitted in the current computing cycle. A second component of the user's reputation is a function of a previously determined reputation RPT−1 for the user from the previous computing cycle. The component of the user's reputation due to the prior reputation RPT−1 is discounted by the decay value D. If the user was relatively inactive and disengaged from the system then the decay value D is smaller (not equal to 1 but a little less, for example, D=0.998) and the impact of the user's earlier reputation RPT−1 is discounted more, whereas if the user is relatively active and engaged with the system then the decay value D is larger (for example, D=1) and the impact of the user's earlier reputation RP−1 is discounted less. As users submit ARs and ROs and use the system, the reputations of the users change. The network-based rating system is usable to solicit and receive challenges from a group of users, and to determine a ranking of the challenges to find the challenge that is likely the best. A ranking of challenges in order of the highest average of ERs for the challenge to the lowest average of ERs for the challenge is maintained and is displayed to users. At the end of a challenge processing period, the highest rated challenge is determined and that challenge is submitted to users in an idea processing step. In other embodiments, challenges submitted by users in the challenge processing step can be submitted to users for ideas in the idea processing step on an ongoing and constant basis. In these alternative embodiments, the challenge rated in the idea processing step may be a challenge other than the highest rated challenge determined in the challenge processing step. In another novel embodiment, the users rating challenges in the challenge processing step are the same users rating ideas in the idea processing step. In yet other embodiments, the users rating challenges in the challenge processing step are not the same users rating ideas in the idea processing step.

In this next section, the high level components of a crowd platform will be disclosed: High-Level Environmental Inputs:

Workflow

(Who Receives/Reviews What—i.e. Fusion) This would be the default workflow that could change or emerge over time as the platform and the crowd evolve.

Decision Makers & Points of Interaction on the Workflow:

1) Identify the decision makers and their level of authority over certain topic areas, etc; 2) Identify what points throughout the process require a manual decision; 3) Identify whether the decision making roles can emerge from the crowd over time.

Overall Budget

(For Reporting & Crowdfunding) Allow departments to pledge certain budget amounts and how they would like it dispersed (crowdfunding, prize-based, rapid prototyping etc.)

Roles/Permissions of Crowd

(Level of Emergent Behavior Allowed) 1) The level of authority the crowd has over the direction or strategy of the platform (i.e. how the crowd shifts focus from a corporate strategic initiative to something else that may be unrelated); 2) Crowd's role for projects under a certain dollar threshold and crowds role for projects over that dollar threshold.

Crowdfunding Type (Standard or Enterprise)

1) Standard—Crowd pitches in; Enterprise—Crowd helps decide where pre-existing budget goes.

Requirements to Validate Challenges

(Graduation Thresholds) 1) proposed challenge becomes a solvable challenge (Workflow); 2) Challenge Attributes.

Requirements to Validate Ideas (Graduation Thresholds) 1) idea validation process; 2) inputs and ideas required for an idea;

Requirements to Validate Implemented Solutions (Graduation Thresholds): How implemented solutions are validated i) quantitatively or ii) qualtitatively by the crowd.

Points Trade-in Options (Tangible Benefit for Participating)

For an explanation of how to make and use the “network based rating system” disclosed in the description above, see U.S. patent application Ser. No. 13/491,560, entitled “User Reputation In Social Network And Ecommerce Rating Systems”, by Manas S. Hardas and Lisa S. Purvis, filed Jun. 7, 2012. The subject matter of application Ser. No. 13/491,560 is incorporated herein by reference.

Although certain specific embodiments are described above for instructional purposes, the teachings of this patent document have general applicability and are not limited to the specific embodiments described above. Although a rating scale involving ratings of −1 and +1 is used in the specific embodiment set forth above, other rating scales can be used. Users may, for example, submit ratings on an integer scale of from one to ten. The rating system need not be a system for rating ideas, but rather may be a system for rating suppliers of products in an ecommerce application. The rating system may be a system for rating products such as in a consumer report type of application. Although specific equations are set forth above for how to calculate a user's reputation and for how to calculate an effective rating in one illustrative example, the novel general principles disclosed above regarding user reputations and effective ratings are not limited to these specific equations. Although in the specific embodiment set forth above a user is a person, the term user is not limited to a person but rather includes automatic agents. An example of an automatic agent is a computer program like a web crawler that generates ROs and submits the ROs to the rating system. Accordingly, various modifications, adaptations, and combinations of various features of the described embodiments can be practiced without departing from the scope of the invention as set forth in the claims.

What is claimed is:

1. A method comprising:
(a) publishing a first challenge to a plurality of users, wherein the first challenge solicits the users to submit second challenges for rating;
(b) storing in a database an initial reputation value for each of the users;
(c) receiving a first of the second challenges from a first user;
(d) receiving an actual rating for the first of the second challenges from a second user;
(e) determining an effective rating for the first of the second challenges that is a function of the initial reputation value for the second user and a probability that the second user followed other users in generating the actual rating;
(f) determining an updated reputation value for the second user based on the effective rating;
(g) replacing the initial reputation value for the second user with the updated reputation value for the first user in the database;
(h) determining a ranking of the second challenges based in part on the effective rating for the first of the second challenges;
(i) determining which of the second challenges has the highest ranking; and
(j) publishing the second challenge having the highest ranking to the plurality of users and soliciting ideas from the plurality of users to solve the second challenge having the highest ranking.

2. The method of claim 1, wherein (a) through (j) are performed by a rating system.

3. The method of claim 1, wherein the determining of (f) involves multiplying the actual rating of (d) by a weighting factor, and wherein the weighting factor is a function of other effective ratings, and wherein the other effective ratings are ratings for second challenges submitted by the second user.

4. The method of claim 1, wherein the determining of (f) involves averaging a plurality of effective ratings, wherein the effective ratings that are averaged are effective ratings for one or more challenges submitted by the first user.

5. The method of claim 1, wherein the determining of (f) involves multiplying the actual rating of (d) by a weighting factor, and wherein the weighting factor is a function of other effective ratings, and wherein the other effective ratings are ratings for rated objects submitted by the second user.

6. The method of claim 1, wherein the determining of (f) involves multiplying the actual rating of (d) by a weighting factor, and wherein the weighting factor is a function of a reputation value for the second user.

7. The method of claim 1, wherein the determining of (f) involves multiplying the actual rating of (d) by a weighting factor, and wherein the weighting factor is a function of a freshness of the actual rating.

8. The method of claim 1, wherein the determining of (f) involves multiplying the actual rating of (d) by a weighting factor, and wherein the weighting factor is a function of the probability that the second user acts with the crowd in generating actual ratings.

9. The method of claim 1, wherein the probability that the second user acts with the crowd in generating actual ratings is a probability given a general sentiment about the challenge rated in (d).

10. The method of claim 1, wherein the determining of the updated reputation value of (d) involves multiplying prior reputation value for the first user by a decay value.

11. The method of claim 1, further comprising the steps of:
(k) receiving a first idea from the first user;
(l) receiving an actual rating for the first idea from the second user;
(m) determining an effective rating for the first idea that is a function of the initial reputation value for the second user and the probability that the second user followed other users in generating the actual rating;
(n) determining an updated reputation value for the second user based on the effective rating of the first idea;
(o) replacing the initial reputation value for the second user with the updated reputation value of (n) for the second user in the database; and
(p) determining a ranking of ideas based in part on the effective rating for the first idea.

12. The method of claim 11, wherein (a) through (p) are performed by a rating system, and wherein the ranking of ideas determined in (p) is displayed by the rating system.

13. A method comprising:
(a) storing a database of rating information, wherein the rating information includes a reputation value for a user of a network-based rating system;
(b) receiving an actual rating of a challenge onto the network-based rating system, wherein the actual rating of a challenge is a rating of one of a plurality of rated challenges;
(c) determining an effective rating based at least in part on the actual rating and the reputation value stored in the database;
(d) adding the effective rating into the database;
(e) determining a ranking of the plurality of rated challenges based at least in part on effective ratings stored in the database, wherein (a) through (e) are performed by the network-based rating system; and
(f) publishing the challenge in (e) having the highest ranking to a plurality of users and soliciting ideas from the plurality of users to solve the challenge having the highest ranking.

14. The method of claim 13, wherein the rating information stored in the database further includes a probability value, wherein the probability value indicates a probability that a user votes with a crowd when the user submits actual ratings, and wherein the determining in (e) of the effective rating is also based on the probability value.

15. The method of claim 13, wherein the determining of (e) involves multiplying the actual rating by a weighting factor, wherein the weighting factor is a function of a probability that a user votes with the crowd when the user submits actual ratings.

16. The method of claim 13, wherein the determining of (e) involves multiplying the actual rating by a weighting factor, wherein the weighting factor is a function of a freshness of the actual rating.

17. The method of claim 13, wherein the determining of (e) involves multiplying the actual rating by a weighting factor, wherein the weighting factor is a function of the reputation value.

18. The method of claim 13, wherein the reputation value for the user was calculated by the network-based rating system based at least in part on an average of effective ratings.

19. The method of claim 13, wherein the reputation value for the user was calculated by the network-based rating system based at least in part on an average of effective ratings for challenges submitted by the user.

20. The method of claim 13, wherein the reputation value for the user was calculated by the network-based rating system, and wherein the calculation of the reputation value involved multiplying a prior reputation value by a decay value.

21. The method of claim 13, wherein the network-based rating system determines a reputation value for each of the plurality of users, the method further comprising:
(f) determining a ranking of the users based at least in part on the reputation values for the plurality of users.

22. A network-based rating system comprising:
means for storing a database of rating information, wherein the rating information includes a plurality of effective ratings, wherein each effective rating corresponds to an actual rating, wherein each actual rating is a rating of one of a plurality of rated challenges, wherein one of the rated challenges was submitted by a first user, and wherein the rated information further includes a plurality of reputation values, wherein one of the reputation values is a reputation value for a second user;
means for determining an effective rating corresponding to an actual rating, wherein the actual rating was submitted by the second user for the rated challenges submitted by the first user, wherein the effective rating is: 1) a function of the actual rating submitted by the second user, and 2) a function of the reputation value for the second user;
means for determining and displaying the highest ranked challenge from a ranking of the plurality of rated challenges based at least in part on effective ratings stored in the database; and
means for receiving actual ratings of ideas from a plurality of users.

23. The network-based rating system of claim 22, wherein the means for storing is a portion of a server that stores database information, and wherein the means for determining an effective rating, the means for determining and displaying the highest ranked challenge, and the means for receiving actual ratings of challenges are parts of a rating system program executing on the server.
